(19) United States
(12) Patent Application Publication
(10) Pub. No.: US 2016/0050706 A1
(43) Pub. Date: Feb. 18, 2016

(54) DUAL CONNECTIVITY FOR TERMINALS SUPPORTING ONE UPLINK CARRIER

(71) Applicant: INTEL IP CORPORATION, Santa Clara, CA (US)

(72) Inventors: Yujian Zhang, Beijing (CN); Hong He, Beijing (CN); Youn Hyoung Heo, San Jose, CA (US); Mo-Han Fong, Sunnyvale, CA (US); Candy Yiu, Portland, OR (US); Ana Lucia Pinheiro, Portland, OR (US)

(21) Appl. No.: 14/778,801

(22) PCT Filed: Dec. 20, 2013
(86) PCT No.: PCT/US13/77163

§ 371 Date: Sep. 21, 2015

Related U.S. Application Data
(60) Provisional application No. 61/808,597, filed on Apr. 4, 2013.

(51) Int. Cl. H04W 76/02; H04W 72/04; H04W 76/04; H04L 5/14

(52) U.S. Cl. CPC H04W 76/025; H04L 5/14; H04W 72/042; H04W 76/04; H04W 92/20

(57) ABSTRACT

Techniques for enabling dual-connectivity in LTE systems for terminals with only single uplink component carrier capability are described. Dual connectivity refers to a terminal having serving cells from two base stations. In one technique, the terminal transmits to macro and small cells using time division multiplexing. In another, the terminal transmits to one cell only, either the macro cell or the small cell.

### PRIORITY CLAIM

This application claims priority to U.S. Provisional Patent Application Ser. No. 61/808,597, filed Apr. 4, 2013, which is incorporated herein by reference in its entirety

### TECHNICAL FIELD

Embodiments described herein relate generally to wireless networks and communications systems.

### BACKGROUND

Dual connectivity, or inter-EUTRA NodeB carrier aggregation (CA), has been proposed for the future enhancement of carrier aggregation in LTE (Long Term Evolution) systems. Carrier aggregation refers to the use of multiple carriers at different frequencies, referred to as component carriers (CCs). There is a serving cell for each component carrier with one serving cell designated as the primary cell (PCell) and the rest as secondary cells (SCells). In dual connectivity, the serving cells are operated in different eNBs (evolved Node Bs). One of the eNBs may be a macro cell eNB, while the other is a small cell eNB. For example, a primary cell may be served from the macro cell, and a secondary cell may be served from the small cell. The main motivation of dual connectivity is to avoid frequent handovers in heterogeneous deployment.

### BRIEF DESCRIPTION OF THE DRAWINGS

FIG. 1 illustrates the entities of an example LTE system.

FIG. 2 shows an example of a UE moving into a macro cell's coverage and into and out of the coverage of two small cells.

FIG. 3 illustrates an example of uplink time division multiplexing for FDD.

FIG. 4 shows an example uplink time division multiplexing for TDD Configuration 1

FIG. 5 illustrates the HARQ operation problem due to X2 latency.

FIG. 6 illustrates the S1 approach for dual connectivity with a single CC UE.

FIG. 7 illustrates an example of UM RLC operation using the X1 approach for dual connectivity with a single CC UE.

FIG. 8 illustrates an example of AM RLC operation using the X1 approach for dual connectivity with a single CC UE.

### DETAILED DESCRIPTION

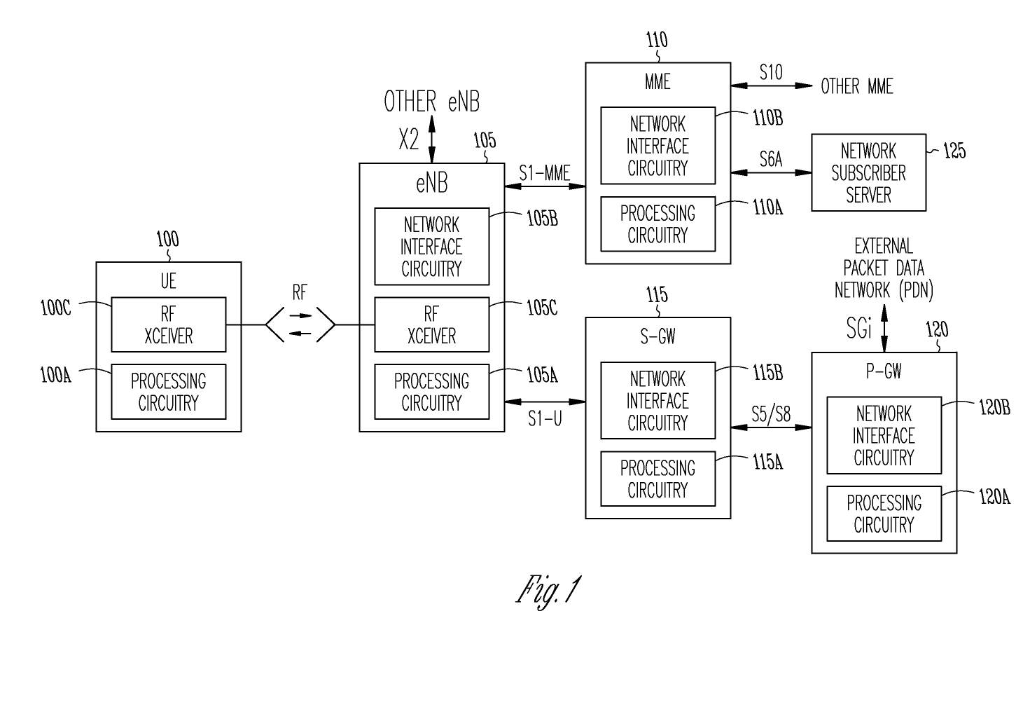

FIG. 1 illustrates the primary network entities of an LTE system where a particular entity may include processing circuitry designated by an “a” suffixed to its reference numeral, network interface circuitry designated by a “b” suffixed to its reference numeral, and a radio-frequency (RF) transceiver with one or more antennas designated by an “c” suffixed to its reference numeral. The eNB (evolved Node B) is a base station that serves terminals, referred to as user equipments (UEs) one or more geographic areas called cells. The eNB 105 provides an RF communications link for the UE 100, sometimes referred to as the LTE radio or air interface. The eNB provides uplink (UL) and downlink (DL) data channels for all of the UEs in its cells and relays data traffic between the UE and the EPC (evolved packet core). The eNB also controls the low-level operation of the UEs by sending them signaling messages. The main components of the EPC are shown as an MME 110 (mobility management entity), an HSS 125 (home subscriber server), an S-GW 115 (serving gateway), and P-GW 120 (packet data network (PDN) gateway). The MME controls the high-level operation of the UE including management of communications sessions, security, and mobility. Each UE is assigned to a single serving MME that may change as the UE moves. The HSS is a central database that contains information about all the network operator's subscribers. The P-GW is the EPC's point of contact with the outside world and exchanges data with one or more packet data networks such as the internet. The S-GW acts as a router between the eNB and P-GW. As with the MME, each UE is assigned to a single serving S-GW that may change as the UE moves.

The air interface provides a communications pathway between the UE and eNB. Network interfaces provide communications pathways between the eNB and the EPC and between the different components of the EPC. The network interfaces include an S1-MME interface between the eNB and the MME, an S1-U interface between the eNB and the S-GW (referred to herein as simply the S1 interface), an X2 interface between different eNBs, an S10 interface between different MMEs, an S6a interface between the MME and the HSS, an S5/S8 interface between the S-GW and the P-GW, and an SGi interface between the P-GW and the PDN. These network interfaces may represent data that is transferred over an underlying transport network. At a high level, the network entities in FIG. 1 communicate across the interfaces between them by means of packet flows, referred to as bearers, which are set up by specific protocols. The UE and eNB communicate over the air interface using both data radio bearers and signaling radio bearers (SRBs). The eNB communicates with the MME over the S1-MME network interface and with the S-GW over the S1-U network interface with like-named bearers. The combination of a data radio bearer, an S1-U bearer, and an S5/S8 bearer is called an EPS (evolved packet system) bearer. The EPC sets up one EPS bearer known as the default bearer whenever a UE connects to the PDN. A UE may subsequently receive other EPS bearers called dedicated bearers.

The LTE air interface, also referred to as the radio interface or radio access network (RAN), has a layered protocol architecture where peer layers of the UE and eNB pass protocol data units (PDUs) between each other that are encapsulated service data units (SDUs) of the next higher layer. The topmost layer in the user plane is the packet data compression protocol (PDCP) layer which transmits and receives IP (internet protocol) packets. The topmost layer of the control plane in the access stratum between the UE and eNB is the radio resource control (RRC) layer. The PDCP layer communicates with the radio link control (RLC) layer via radio bearers to which IP packets are mapped. At the medium access control (MAC) layer, the connection to the RLC layer above is through logical channels, and the connection to the physical layer below is through transport channels. The MAC layer handles multiplexing/demultiplexing between the logical channels, hybrid-ARQ operations, and scheduling, the latter being performed solely at the eNB for both the uplink and the downlink. Data in a transport channel is organized into transport blocks, with respect to which the hybrid-ARQ function (explained below) is performed at both the UE and eNB. The primary transport channels used for the transmission of data, the uplink shared channel (UL-SCH) and downlink shared channel (DL-SCH), are mapped to the physical uplink shared channel (PUSCH) and physical downlink shared channel (PDSCH), respectively, at the physical layer.

LTE uses a combination of forward error-correction coding and ARQ (automatic repeat request), referred to as hybrid ARQ or HARQ. Hybrid ARQ uses forward error correction codes to correct some errors. As the term is used herein, a hybrid-ARQ acknowledgement or ACK may either be a negative acknowledgement, signifying that a transmission error has occurred and that a retransmission is requested, or a positive acknowledgement indicating that the transmission was received. The HARQ function operates in the MAC layer. The RLC layer also has a mechanism to further provide for error-free delivery of data to higher layers by having a retransmission protocol that operates between the RLC entities in the receiver and transmitter.

The physical layer of LTE is based upon orthogonal frequency division multiplexing (OFDM) for the downlink and a related technique, single carrier frequency division multiplexing (SC-FDM), for the uplink. In OFDM/SC-FDM, complex modulation symbols according to a modulation scheme such as QAM (quadrature amplitude modulation) are each individually mapped to a particular OFDM/SC-FDM subcarrier transmitted during an OFDM/SC-FDM symbol, referred to as a resource element (RE). LTE transmissions in the time domain are organized into radio frames, each having a duration of 10 ms. Each radio frame consists of 10 sub-frames, and each sub-frame consists of two consecutive 0.5 ms slots. Each slot comprises six indexed OFDM symbols for an extended cyclic prefix and seven indexed OFDM symbols for a normal cyclic prefix. A group of resource elements corresponding to twelve consecutive subcarriers within a single slot is referred to as a resource block (RB) or, with reference to the physical layer, a physical resource block (PRB). In the case of FDD (frequency division duplex) operation, where separate carrier frequencies are provided for uplink and downlink transmission, the above-described frame structure is applicable to both the uplink and downlink without modification. In TDD (time division duplex) operation, subframes are allocated for either uplink or downlink transmission with a special subframe occurring at the transition from downlink to uplink transmission (but not at the transition from uplink to downlink transmission). The eNB manages the allocation of uplink and downlink subframes within each radio frame during TDD operation.

A physical channel corresponds to the set of time-frequency resources used for transmission of a particular transport channel, and each transport channel is mapped to a corresponding physical channel. There are also physical control channels without a corresponding transport channel that are needed for supporting the transmission of the downlink and uplink transport channels. These include the physical downlink control channel (PDCCH), by which the eNB transmits downlink control information (DCI) to the UE, and the physical uplink control channel (PUCCH) that carries uplink control information (UCI) from the UE to the eNB. Insofar as is relevant to the present disclosure, the DCI carried by the PDCCH may include scheduling information that allocates uplink and downlink resources to the UE, while the UCI carried by the PUCCH may include hybrid-ARQ acknowledgements for responding to transport blocks received by the UE.

### Dual Connectivity

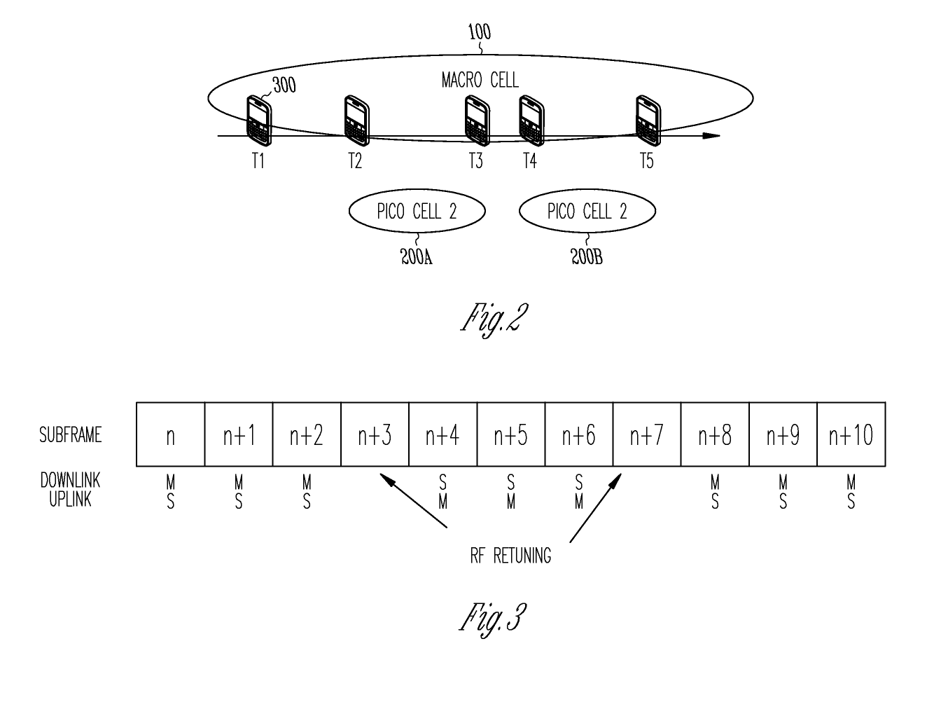

FIG. 2 shows an example where UE 100 moves within macro cell 600 coverage at time t1, within small cell 650a coverage at time t2, out of small cell 650a coverage at time t3, within small cell 650b coverage at time t4, and out of small cell 650b coverage at time t5. Since the coverage of the small cell is smaller than that of macro cell, the UE needs to handover to macro cell or other small cell if the UE is connected to the small cell only. On the other hand, if the UE is connected to the macro cell, handover is not required but offloading to the small cell cannot be provided. Therefore, to achieve offloading and avoid the frequent handover, carrier aggregation can be supported where the UE is served by both macro cell and small cell. The PCell can be connected to the macro cell and the SCell can be connected to the small cell. Since the PCell is responsible for the mobility management, the UE does not need to handover as long as the UE is moving within the macro cell. Furthermore, the SCell connected to the small cell is used for data transmission and the UE can take advantage of offloading to the small cell. The change from the small cell 650a to small cell 650b is supported with SCell addition/removal instead of handover. In this scenario, the main difference between dual connectivity and conventional CA is that the macro cell and the small cell are served by the different eNBs and two cells are connected through X2 interface. In conventional CA, it is assumed that all serving cells are served by the same eNB.

Uplink capability is one of the most important factors for dual connectivity supporting from the UE's perspective. One straightforward option is for the UE to always be required to have a UL CA capability in order for dual connectivity to be supported. However, UL CA generally incurs high-complexity implementations for the UE. Two Tx (transmit) RF chains dramatically increases UE complexity as well as cost. Moreover, inter-modulation may be generated whenever simultaneous transmission of multiple CCs occurs. Discussed below are two basic options for a UE to support dual-connectivity with only single UL CC capability: 1) the UE transmits to macro and small cell in TDM fashion, and 2) the UE transmits to one cell (either the macro cell or the small cell) only.

### Dual Connectivity Via TDM Option

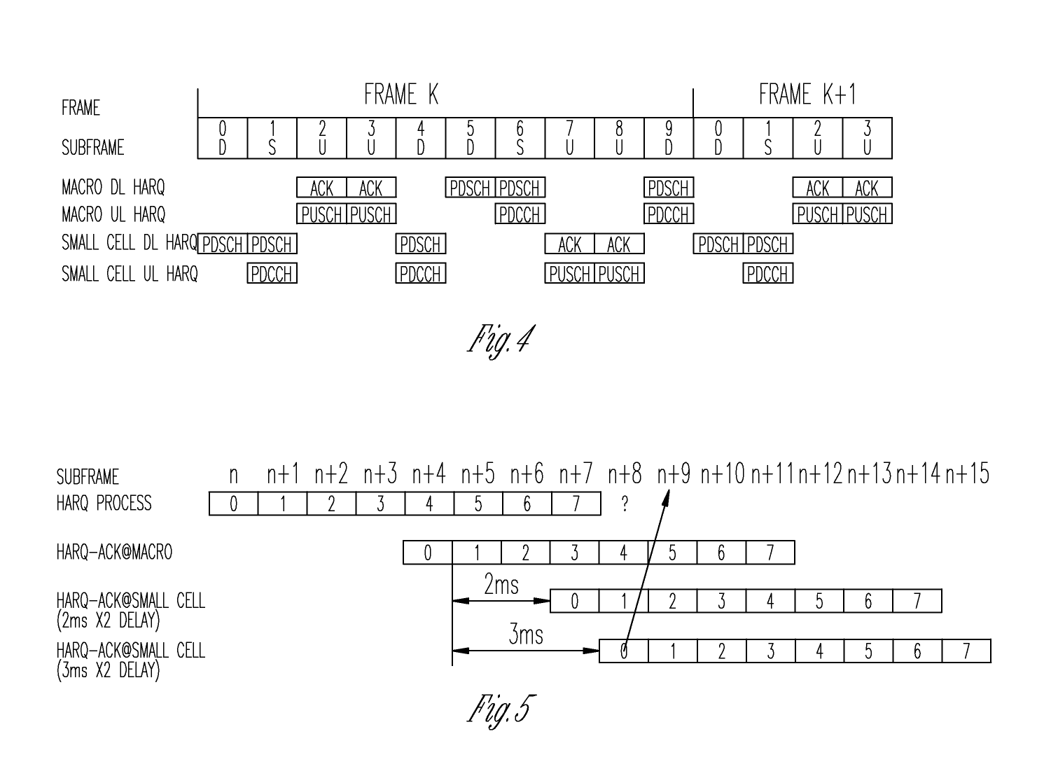

One example of the TDM option for FDD is shown in FIG. 3. In this example, within 8 ms period (i.e., the FDD UL HARQ timing period), the UE can receive DL transmissions in subframes n/n+1/n+2 from the macro cell, and transmit HARQ-ACK to the macro cell in subframes n+4/n+5/n+6 accordingly. Simultaneously, the UE can receive DL transmission in subframes n+4/n+5/n+6 from small cell, and feedback HARQ-ACKs to small cell in subframes n/n+1/n+2. For UL transmission, since UE switches the transmission frequencies after subframe n+2, even if a few hundred microseconds is needed for RF retuning, at least one subframe cannot be used for UL transmission (e.g. subframe n+3 and n+7 in FIG. 2). Due to HARQ timing relationships, these subframes cannot be used for DL transmission as well. Such RF retuning subframes reduces the available subframes for DL and UL transmissions and therefore also reduces the peak data rate and eNB scheduling flexibility.

For TDD mode using TDM option, one way to eliminate RF retuning subframes is to group contiguous UL subframes to the same cell. In this way UE can use DL subframes in between to switch UL frequencies. An example is shown in FIG. 4 for TDD Configuration 1 as defined by the LTE specifications. The UE transmits to macro cell in subframe #2 and #3 and transmits to the small cell in subframe #7 and #8. For the DL, the UE receives from macro cell in subframe #5, #6 and #9, and receives from the small cell in subframe #0, #1 and #4.

If TDD mode with TDM is employed to enable dual connectivity for the UE to a macro cell and a small cell, the small cell may communicate with the S-GW via an S1 interface. Alternatively, data to and from the S-GW for the small cell may be relayed by the macro cell via an X2 interface.

### Dual Connectivity Via UE Transmission to One Cell Only

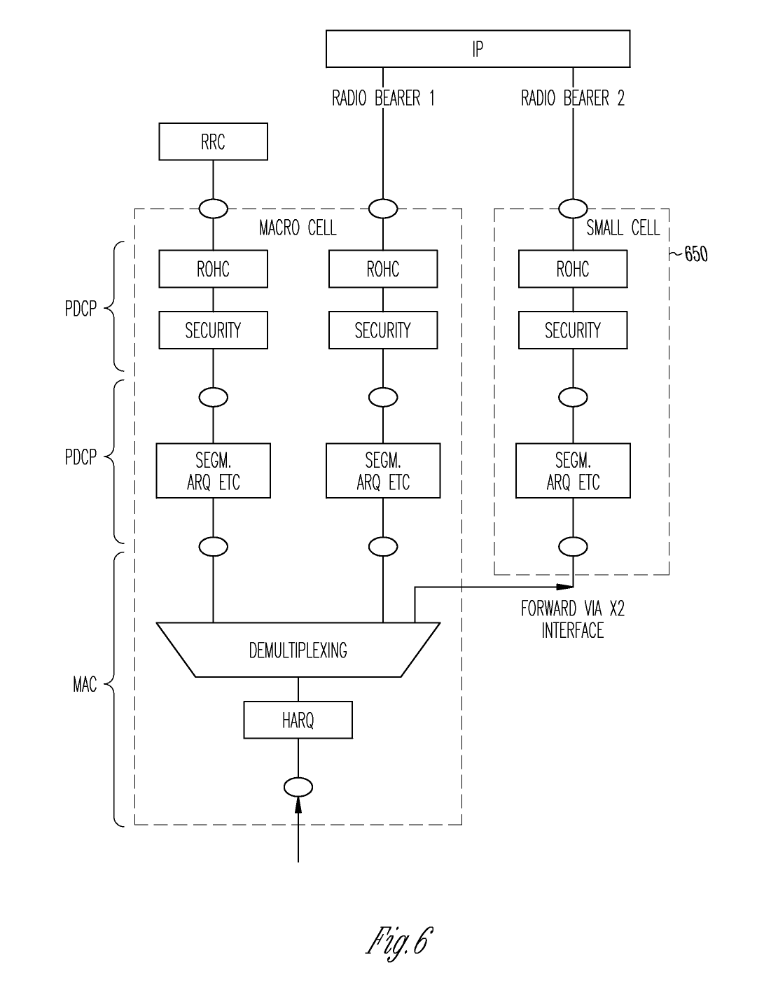

When the UE transmits to one cell (e.g., the macro cell) only, the macro cell needs to forward HARQ-ACK/CSI signaling to the small cell via the X2 interface that may be provided between different eNBs. The key principle behind the number of HARQ processes as defined by the current LTE specifications is that the number of HARQ processes should cover the longest HARQ Round Trip Time (RTT). Due to the X2 latency introduced when the macro cell forwards HARQ acknowledgements to the small cell, the number of HARQ processes is not sufficient to cover the increased HARQ RTT. For HARQ-ACK, such latency might have impact on achievable peak data rate. Although DL HARQ is asynchronous, there are fixed number of HARQ processes according to the duplex mode (in case of TDD, the number of HARQ processes also depends on DL/UL configuration). FIG. 5 illustrates the issue for FDD operation. If X2 delay latency is less than 3 ms (and disregarding the processing time at macro cell for HARQ-ACK and the scheduling time at the small cell), then the HARQ-ACK for HARQ process 0 can be received before subframe n+8 at the small cell. The small cell can therefore decide whether to transmit new data or perform retransmission for HARQ process 0 at subframe n+8. In this case, the peak data rate can be achieved. However, if X2 delay latency is larger than 3 ms, then for subframe n+8, HARQ-ACKs for all HARQ processes are not received by small cell. Therefore the small cell cannot make scheduling decisions for subframe n+8. For non-ideal backhaul, it is expected that typical X2 latency is larger than 3 ms, which means that DL peak data rate for one UL CC cannot be achieved. Another perspective is that small cell does not have much scheduling flexibility due to the delayed HARQ-ACK. For TDD, although TDD has longer HARQ RTT, the impact is the same. The reason is that, since maximum number of HARQ processes is determined by the largest HARQ RTT, X2 latency increases the largest HARQ RTT. The current number of HARQ processes in accordance with the current LTE specifications is thus not sufficient.

One solution to the X2 latency problem is to increase the number of DL HARQ processes to cover the largest HARQ RTT. Currently, in PDCCH, the number of bits to indicate HARQ process is 3 and 4 for FDD and TDD respectively. The number of bits can be extended to m (m>3) and n (n>4) for FDD and TDD respectively. As a special case, the number of bits for HARQ process number identification in DCI (downlink control information) format 1 can be increased to 4 and 5 for FDD and TDD, respectively. Those values are 3 and 4 for FDD and TDD, respectively, according the current LTE specifications, and the changes would double the number of HARQ processes. Similar changes could be made for other DCI formats.

There are basically two approaches to route the EPS bearers handled by the small cell. In the first approach, which may be called an S1 approach, the small cell eNB, once configured by the macro eNB, directly communicates with the S-GW via the S1 interface. In the second approach, which may be referred to as an X2 approach, the macro eNB needs to forward data to the small cell eNB via the X2 interface, and the macro eNB also needs to be able to receive data from the small cell eNB and send it over the S1 interface to the S-GW. In the embodiments described below, it is assumed that the UE only transmits to the macro cell, and the macro cell forwards necessary information to small cell. It is also possible for the UE to only transmit to the small cell and for the small cell to forward necessary information to the macro cell. Those embodiments would involve simply exchanging the terms macro cell and small cell in the descriptions below.

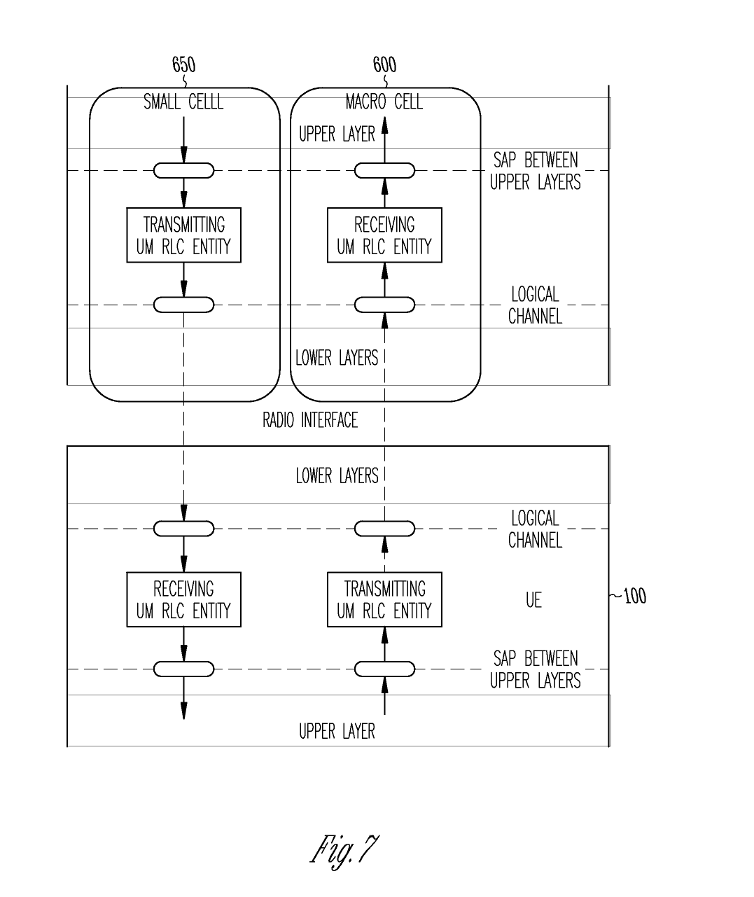

For the S1 approach, one method for the macro cell to forward received UL data to the small cell is as follows. After the macro cell receives UL data, the MAC layer performs demultiplexing, and the macro cell then forwards the RLC PDUs (protocol data units) to the small cell if necessary. The RLC protocol split for the uplink is shown in FIG. 6 for a UE 100, a macro cell eNB 600, and a small cell eNB 650 for a radio bearer 1 set up between the macro cell eNB and the UE and a radio bearer 2 set up between the small cell eNB and the UE. The MAC layer in the macro cell performs demultiplexing of UL data. Radio bearer 1 is handled by the macro cell directly so that, after demultiplexing, RLC PDUs of radio bearer 1 are passed to the RLC layer of the macro cell. For radio bearer 2, after demultiplexing at the MAC layer, the macro cell forwards RLC PDUs to the small cell via the X2 interface. The small cell then handles RLC and PDCP layer processing and transports the data to the S-GW via the S1 interface.

In the X2 approach, the macro cell eNB forwards data received from the S-GW over an S1 interface to the small cell eNB over the X2 interface when that received data is associated with a radio bearer set up between the small cell eNB and the UE. The macro cell eNB also may forward data received from the small cell eNB over the X2 interface to the S-GW over the S1 interface when the data received from the small cell eNB is associated with a radio bearer set up between the small cell eNB and the UE.

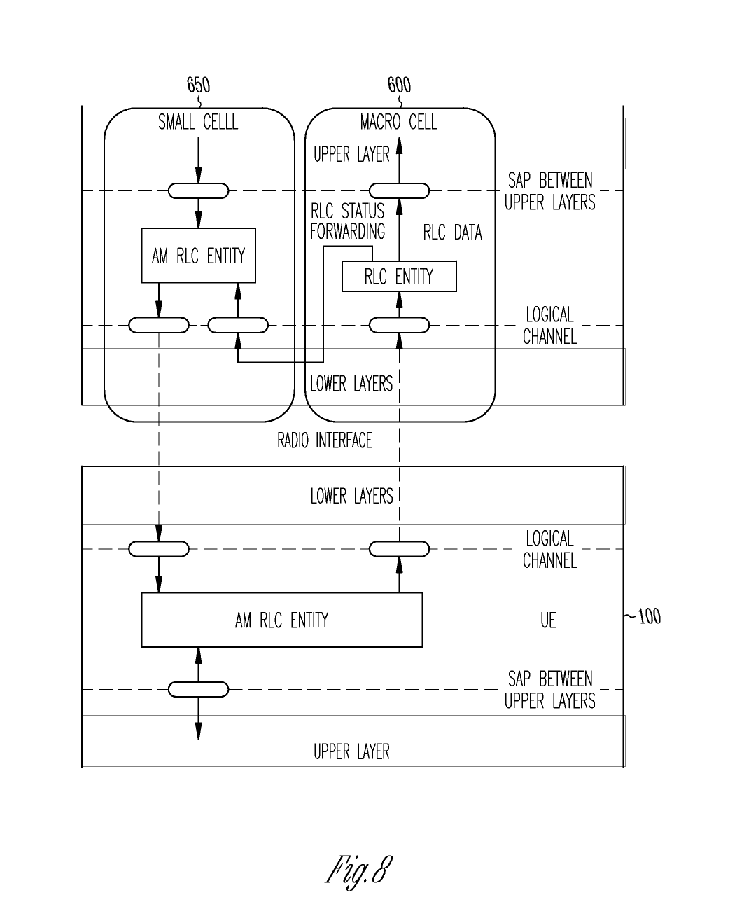

An embodiment for the X2 approach is as shown in FIG. 7 that illustrates the RLC protocol layer for a UE 100, a macro cell eNB 600, and a small cell eNB 650. The RLC layer in each device may include transmitting or receiving RLC entities and communicates with lower layers via logical channels and with upper layers via a service access point (SAP). There are three types of RLC entities: TM, UM, and AM entities (for transparent mode, unacknowledged mode, and acknowledged mode, respectively). Data bearers can only be mapped to UM or AM RLC entities. For a UM RLC entity, the transmitting and receiving entities can operate independently. The macro cell can therefore provide a receiving UM RLC entity that corresponds to the UE's UL transmitting UM RLC entity. The UE provides a receiving UM RLC entity that corresponds to the small cell's DL transmitting UM RLC entity. The macro cell does not have to perform forwarding of the UL bearer which is associated with the DL bearer transmitted by the small cell. The macro cell handles the reception from the UE through the physical, MAC, RLC, and PDCP layers and then transports the data to the S-GW.

For AM RLC, there is only one AM RLC entity within a communication peer, and that AM RLC entity handles both transmission and reception. RLC PDUs have two types: RLC data PDUs and RLC control PDUs (i.e., an RLC status PDU). Both RLC data PDUs and RLC status PDUs contain a polling bit (P) field which indicates whether or not the transmitting side of an AM RLC entity requests a STATUS report from its peer AM RLC entity. To enable AM RLC operation when the UL has only one CC, the macro cell eNB forwards RLC status PDUs and polling bits received from the UE to the small cell eNB via the X2 interface. An example is shown in FIG. 8 that shows the RLC protocol layer for a UE 100, a macro cell eNB 600, and a small cell eNB 650 where the RLC layer communicates with lower layers via logical channels and with upper layers via a service access point (SAP). The RLC layers of the small cell and UE include corresponding AM RLC entities, and the RLC layer of the macro cell includes an RLC entity for forwarding RLC status PDUs and polling bits from the UE to the AM RLC entity of the small cell. The macro cell also processes RLC data PDUs from the UE and passes them to the PDCP layer for further processing. The macro cell's RLC entity may also handle some RLC functions such as RLC header processing and reordering. In another aspect, there are three RLC timers: t-PollRetransmit, t-Reordering, and t-StatusProhibit. The value of all three timers can be configured with RRC signaling. Additional values may be added to these timers in order to accommodate X2 interface latency.

### Additional Notes and Examples

In Example 1, a method for operating an evolved Node B (eNB) as a macro cell in an LTE (Long Term Evolution) network, comprises: communicating via an X2 interface with a small cell eNB serving as a secondary cell for a user equipment (UE); operating as a primary cell for the UE in time division duplex (TDD) mode; and, allocating downlink (DL) and uplink (UL) subframes between the UE and the macro cell eNB over a first component carrier and between the UE and the small cell eNB over a second component carrier in a manner that allows the UE to switch UL carrier frequencies during DL subframes.

In Example 2, the subject matter of Example 1 may optionally include contiguously grouping UL subframes to the macro cell and contiguously grouping UL subframes to the small cell eNB with DL subframes therebetween in order to allow the UE to use DL subframes between the UL subframes to switch UL carrier frequencies.

In Example 3, the subject matter of Example 1 may optionally include relaying data to and from a serving gateway (S-GW) for the small cell eNB.

In Example 4, method for operating an evolved Node B (eNB) g as a macro cell in an LTE (Long Term Evolution) network, comprises: operating as a primary cell for a user equipment (UE) when a small cell eNB operates as a secondary cell for the UE and when no uplink transmissions are allowed for the UE over the secondary cell; forwarding HARQ (hybrid automatic repeat request) acknowledgements and CSI (channel state information) reports from the UE to the small cell eNB via an X2 interface; and, after receiving, in a MAC (medium access control) layer, data from the UE that includes RLC (radio link control) PDUs (protocol data units) associated with a radio bearer set up between the UE and the small cell eNB, forwarding the RLC PDUs to the small cell eNB over the X2 interface.

In Example 5 the subject matter of Example 4 may optionally include transmitting DCI (downlink control information) in a PDCCH (physical downlink control channel) with a four-bit HARQ process number field for frequency division duplex (FDD) mode and/or with a five-bit HARQ process number field for time division duplex (TDD) mode.

In Example 6 the subject matter of Example 5 may optionally include providing sixteen HARQ processes for FDD mode and/or thirty HARQ processes for TDD mode.

In Example 7, a method for operating an evolved Node B (eNB) as a macro cell in an LTE (Long Term Evolution) network, comprises: operating as a primary cell for a user equipment (UE) when a small cell eNB operates as a secondary cell for the UE and when no uplink transmissions are allowed for the UE over the secondary cell; and, forwarding data received from an S-GW (serving gateway) over an S1 interface to the small cell eNB over an X2 interface when that received data is associated with a radio bearer set up between the small cell eNB and the UE.

In Example 8 the subject matter of Example 7 may optionally include forwarding data received from the small cell eNB over the X2 interface to the S-GW over the S1 interface when that received data is associated with a radio bearer set up between the small cell eNB and the UE.

In Example 9 the subject matter of Example 7 may optionally include, when the small cell eNB is transmitting to the UE in RLC acknowledged mode, forwarding RLC status PDUs from the UE to the small cell eNB over the X2 interface.

In Example 10 the subject matter of Example 7 may optionally include, when the small cell eNB is transmitting to the UE in RLC acknowledged mode, forwarding RLC data PDUs with a polling bit from the UE to the small cell eNB over the X2 interface.

In Example 11 the subject matter of Example 7 may optionally include transmitting DCI (downlink control information) in a PDCCH (physical downlink control channel) with a four-bit HARQ process number field for frequency division duplex (FDD) mode and/or with a five-bit HARQ process number field for time division duplex (TDD) mode.

In Example 12 the subject matter of Example 7 may optionally include providing sixteen HARQ processes for FDD mode and/or thirty HARQ processes in TDD mode.

In Example 13, a method for operating a user equipment (UE), comprises: communicating with a macro cell evolved Node B (eNB) serving as a primary cell for a first component carrier; communicating with a small cell evolved Node B (eNB) serving as a secondary cell for a second component carrier; in time division duplex (TDD) mode, receiving allocations of downlink (DL) and uplink (UL) subframes between the UE and the macro cell eNB over a first component carrier and between the UE and the small cell eNB over a second component carrier; and, switching UL carrier frequencies during DL subframes.

In Example 14 the subject matter of Example 13 may optionally include receiving allocations of contiguously grouped UL subframes to the macro cell eNB and contiguously grouped UL subframes to the small cell eNB.

In Example 15 the subject matter of Example 13 may optionally include receiving allocations of UL subframes to the macro cell eNB and UL subframes to the small cell eNB with DL subframes therebetween in order to allow the UE to use DL subframes between the UL subframes to switch UL carrier frequencies.

In Example 16, a method for operating a user equipment (UE), comprises: communicating with a macro cell evolved Node B (eNB) serving as a primary cell for both uplink (UL) and downlink (DL) transmissions; and, communicating with a small cell eNB serving as a secondary cell for DL transmissions but not UL transmissions.

In Example 17, the subject matter of Example 16 may optionally include establishing hybrid automatic request repeat (HARQ) processes in accordance with DCI (downlink control information) in a PDCCH (physical downlink control channel) having a four-bit HARQ process number field in frequency division duplex (FDD) mode and/or a five-bit HARQ process number field in time division duplex (TDD) mode.

In Example 18, the subject matter of Example 16 may optionally include establishing establishing sixteen HARQ processes in FDD mode and/or thirty HARQ processes in TDD mode.

In Example 19, an evolved Node B (eNB) for operating as a macro cell in an LTE (Long Term Evolution) network, comprises: a radio interface for communicating with a user equipment (UE); an X2 interface for communicating with a small cell eNB; wherein the processing circuitry is to perform any of the methods set forth in Examples 1 through 12.

In Example 20, a user equipment (UE) comprises: a radio transceiver and processing circuitry; wherein the processing circuitry is to perform any of the methods set forth in Examples 13 through 18.

In Example 21, a computer-readable medium contains instructions for performing any of the methods set forth in Examples 1 through 18.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the invention is not limited in this respect. An example LTE system includes a number of mobile stations, defined by the LTE specification as User Equipment (UE), communicating with a base station, defined by the LTE specifications as an eNodeB.

Antennas referred to herein may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

In some embodiments, a receiver as described herein may be configured to receive signals in accordance with specific communication standards, such as the Institute of Electrical and Electronics Engineers (IEEE) standards including IEEE 802.11-2007 and/or 802.11(n) standards and/or proposed specifications for WLANs, although the scope of the invention is not limited in this respect as they may also be suitable to transmit and/or receive communications in accordance with other techniques and standards. In some embodiments, the receiver may be configured to receive signals in accordance with the IEEE 802.16-2004, the IEEE 802.16(e) and/or IEEE 802.16(m) standards for wireless metropolitan area networks (WMANs) including variations and evolutions thereof, although the scope of the invention is not limited in this respect as they may also be suitable to transmit and/or receive communications in accordance with other techniques and standards. In some embodiments, the receiver may be configured to receive signals in accordance with the Universal Terrestrial Radio Access Network (UTRAN) LTE communication standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, release 8, March 2008, including variations and evolutions thereof.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-20. (canceled)

21. A method for operating an evolved Node B (eNB) as a macro cell in an LTE (Long Term Evolution) network, comprising:
communicating via an X2 interface with a small cell eNB serving as a secondary cell for a user equipment (UE);
operating as a primary cell for the UE in time division duplex (TDD) mode; and,
allocating downlink (DL) and uplink (UL) subframes between the UE and the macro cell eNB over a first component carrier and between the UE and the small cell eNB over a second component carrier in a manner that allows the UE to switch UL carrier frequencies during DL subframes.

22. The method of claim 21 further comprising contiguously grouping UL subframes to the macro cell and contiguously grouping UL subframes to the small cell eNB with DL subframes therebetween in order to allow the UE to use DL subframes between the UL subframes to switch UL carrier frequencies.

23. The method of claim 21 further comprising relaying data to and from a serving gateway (S-GW) for the small cell eNB.

24. A method for operating an evolved Node B (eNB) g as a macro cell in an LTE (Long Term Evolution) network, comprising:
operating as a primary cell for a user equipment (UE) when a small cell eNB operates as a secondary cell for the UE and when no uplink transmissions are allowed for the UE over the secondary cell;
forwarding HARQ (hybrid automatic repeat request) acknowledgements and CSI (channel state information) reports from the UE to the small cell eNB via an X2 interface; and,
after receiving, in a MAC (medium access control) layer, data from the UE that includes RLC (radio link control) PDUs (protocol data units) associated with a radio bearer set up between the UE and the small cell eNB, forwarding the RLC PDUs to the small cell eNB over the X2 interface.

25. The method of claim 24 further comprising transmitting DCI (downlink control information) in a PDCCH (physical downlink control channel) with a four-bit HARQ process number field for frequency division duplex (FDD) mode and with a five-bit HARQ process number field for time division duplex (TDD) mode.

26. The method of claim 25 further comprising providing sixteen HARQ processes for FDD mode.

27. A method for operating an evolved Node B (eNB) as a macro cell in an LTE (Long Term Evolution) network, comprising:
operating as a primary cell for a user equipment (UE) when a small cell eNB operates as a secondary cell for the UE and when no uplink transmissions are allowed for the UE over the secondary cell; and,
forwarding data received from an S-GW (serving gateway) over an Si interface to the small cell eNB over an X2 interface when that received data is associated with a radio bearer set up between the small cell eNB and the UE.

28. The method of claim 27 further comprising forwarding data received from the small cell eNB over the X2 interface to the S-GW over the S1 interface when that received data is associated with a radio bearer set up between the small cell eNB and the UE.

29. The method of claim 27 further comprising, when the small cell eNB is transmitting to the UE in RLC acknowledged mode, forwarding RLC status PDUs from the UE to the small cell eNB over the X2 interface.

30. The method of claim 27 further comprising, when the small cell eNB is transmitting to the UE in RLC acknowledged mode, forwarding RLC data PDUs with a polling bit from the UE to the small cell eNB over the X2 interface.

31. The method of claim 27 further comprising transmitting DCI (downlink control information) in a PDCCH (physical downlink control channel) with a four-bit HARQ process number field for frequency division duplex (FDD) mode and with a five-bit HARQ process number field for time division duplex (TDD) mode.

32. The method of claim 27 further comprising providing sixteen HARQ processes for FDD mode.

33. A method for operating a user equipment (UE), comprising:
communicating with a macro cell evolved Node B (eNB) serving as a primary cell for a first component carrier;
communicating with a small cell evolved Node B (eNB) serving as a secondary cell for a second component carrier;
in time division duplex (TDD) mode, receiving allocations of downlink (DL) and uplink (UL) subframes between the UE and the macro cell eNB over a first component carrier and between the UE and the small cell eNB over a second component carrier; and,
switching UL carrier frequencies during DL subframes.

34. The method of claim 33 further comprising receiving allocations of contiguously grouped UL subframes to the macro cell eNB and contiguously grouped UL subframes to the small cell eNB.

35. The method of claim 33 further comprising receiving allocations of UL subframes to the macro cell eNB and UL subframes to the small cell eNB with DL subframes therebetween in order to allow the UE to use DL subframes between the UL subframes to switch UL carrier frequencies.

36. A method for operating a user equipment (UE), comprising:
communicating with a macro cell evolved Node B (eNB) serving as a primary cell for both uplink (UL) and downlink (DL) transmissions; and,
communicating with a small cell eNB serving as a secondary cell for DL transmissions but not UL transmissions;

37. The method of claim 36 further comprising establishing hybrid automatic request repeat (HARQ) processes in accordance with DCI (downlink control information) in a PDCCH (physical downlink control channel) having a four-bit HARQ process number field in frequency division duplex (FDD) mode.

38. The method of claim 36 further comprising establishing hybrid automatic request repeat (HARQ) processes in accordance with DCI (downlink control information) in a PDCCH (physical downlink control channel) having a five-bit HARQ process number field in time division duplex (TDD) mode.

39. The method of claim 37 further comprising establishing sixteen HARQ processes in FDD mode.

40. The method of claim 38 further comprising establishing thirty HARQ processes in TDD mode.
